(19) United States
(12) Patent Application Publication
(10) Pub. No.: US 2025/0211837 A1
(43) Pub. Date: Jun. 26, 2025

(54) IMPROVED MANAGEMENT OF A VISUAL CODE DURING DISPLAY IN MULTIMEDIA CONTENT

(71) Applicant: ORANGE, Issy-les-Moulineaux (FR)

(72) Inventors: Patrick KIRSCHBAUM, Chatillon (FR); Halim BENDIABDALLAH, Chatillon (FR)

(21) Appl. No.: 18/849,197

(22) PCT Filed: Mar. 21, 2023
(86) PCT No.: PCT/EP2023/057128

§ 371 Date: Sep. 20, 2024

(30) Foreign Application Priority Data
Mar. 23, 2022 (FR) 2202564

(51) Int. Cl. H04N 21/858; H04N 21/422; H04N 21/462

(52) U.S. Cl. CPC H04N 21/858; H04N 21/42203; H04N 21/4221; H04N 21/4622

(57) ABSTRACT

For transmission of data associated with a visual code appearing at least temporarily in multimedia content during playing on a connected screen, the following are provided: establishing a pairing between the screen and at least one second connected terminal, distinct from the connected screen; at least during playing the multimedia content including the visual code, making available to a user a human-machine interface connected to the screen for sending a request for data associated with the visual code; and upon receiving the request, implementing a transmission of the data associated with the visual code to the second connected terminal, the visual code appearing at a given timestamp after beginning of playing the multimedia content, a request for data associated with the visual code, coming from the connected screen, being interpreted as associated with the visual code if the request is received in a preset time span after the timestamp.

### FIELD OF THE INVENTION

The present disclosure relates to the field of the transmission of data associated with a visual code appearing at least temporarily in multimedia content.

### DESCRIPTION OF RELATED ART

Such a visual code may for example be a one-or two-dimensional barcode type, also known as “QR code” for quick response code.

Such codes may be shown temporarily in multimedia content, such as a television program being broadcast. Optically reading such a code, for example by means of a smart phone type terminal, can typically retrieve information on the smart phone about the service associated with this code (for example after following a hypertext link displayed on the smart phone).

Thus, some television programs display a QR code type 2D code to get access to information from via mobile terminal. Sometimes, the length of the display of this code is of order a few seconds at most.

A viewer must then take a picture with a barcode reader application on their smart phone.

However, not all viewers necessarily have this application on their smart phone, or even have their smart phone within reach while watching the television, or again some are not very comfortable with this operation.

Further, such an operation involves getting up and getting closer to the television screen while broadcasting the program in order to correctly read the visual code with their smart phone and sometimes the time during which the code is displayed is not sufficient to successfully perform this operation.

### BRIEF SUMMARY OF THE INVENTION

The present disclosure aims to improve the situation.

A method is proposed for transmission of data associated with a visual code appearing at least temporarily in multimedia content during playing on a connected screen, where the method comprises:
establishing a pairing between the screen and at least one second connected terminal, distinct from the connected screen;
at least during playing the multimedia content comprising said code, making available to a user of the screen a human-machine interface connected to the screen for sending a request for data associated with the visual code; and
upon receiving the request for data associated with the visual code near the connected screen, implement a transmission of said data associated with the visual code to the second connected terminal;
   the visual code appearing at a given timestamp after beginning of playing the multimedia content, a request for data associated with the visual code, coming from the connected screen, is interpreted as associated with the visual code if the request is received in a preset time span after said given timestamp.

Thus, in such an implementation, the user only needs to activate the human-machine interface connected to the screen (for example a TV remote control with a specific button) in order to launch a request for data associated with the visual code during display by the screen, and, in that way, the user's second terminal (for example a smart phone distinct from the television screen) receives these data, without disrupting playing the multimedia content nor disturbing the user while playing.

Advantageously, such a time span may consider the user's reaction latency and extend over a minute or longer, for example.

For example, in an implementation, the screen may be connected to a remote server for receiving and playing the multimedia content, and:
the connected screen sends this remote server the request for data associated with the visual code, and
since pairing data is stored in the memory of the remote server, the remote server, based on this pairing data, identifies the second terminal as recipient of the data associated with the visual code.

Thus, the second terminal may receive (for example by SMS or other messaging means) the data associated with the visual code.

Alternatively to such an implementation, the connected screen may send the second terminal these data that it previously acquired from the server, for example by a local network controlled by a gateway and to which both the second terminal and the connected screen are connected. This alternate implementation is described in detail later.

For example, the second terminal receives these data in the form of an access link to a service associated with the visual code (for example an HTML or other type hypertext link).

In an implementation example, the multimedia content is received by the connected screen by implementation of a broadcast protocol. Thus, this content may typically be a television program, for example.

The broadcast protocol may for example be HBBTV (Hybrid Broadcast Broadband TV) type, for example over IP. Such a protocol in particular provides the advantage of including in the flow of TV image data metadata describing events in the flow, like for example the intended appearance of the aforementioned visual code, with in particular an intended timestamp for such an appearance.

In an implementation, the visual code is typically a barcode (one-or two-dimensional) for which an optical reader is typically able to retrieve the data associated with the visual code, where these data are associated with a service accessible through the second terminal (for example via a hypertext link). Nonetheless, in the present disclosure, the human-machine interface uses a means distinct from a conventional optical reader for requesting the data associated with the visual code.

For example, the human-machine interface may comprise a remote control comprising a specific button, where pressing this specific button causes the transmission of the request for the data associated with the visual code.

Alternatively or additionally, the human-machine interface may comprise a voice recognition module (and more specifically speech recognition), and speaking by the user of at least one specific keyword (or a predefined succession of specific keywords) causes the transmission of the request for the data associated with the visual code.

In the case of a specific remote-control button, the connected screen may be integrated with a connected television, and the human-machine interface available to the user may then comprise a television remote control, where this remote control comprises a specific button for sending the request for the data associated with the visual code.

In addition or as a variant, the screen may further be connected to a terminal for receiving content, like a set-top box, and the human-machine interface available to the user may comprise a set-top box remote control, where this remote control then comprises the aforementioned specific button for issuing the request for said data associated with the visual code.

The present disclosure also targets a connected screen, configured for displaying multimedia content in which a visual code appears at least temporarily, where the screen comprises:
a first communication interface with a human-machine interface for receiving a command to receive data associated with the visual code; and
a second communication interface with a remote server for sending a request for said data associated with the visual code to the server;
   the visual code appearing at a given timestamp after beginning of playing the multimedia content, a request for data associated with the visual code, coming from the connected screen, is interpreted as associated with the visual code if the request is received in a preset time span after said given timestamp.

The present disclosure also targets the system comprising at least one connected screen and a human-machine interface, for implementing the process defined above.

In such a system, the aforementioned human-machine interface may then comprise a remote control comprising a specific button for sending the request for said data associated with the visual code.

Just the same, such an implementation is optional and in a variant calling for a remote control having a specific button, a specific button may be provided on a computer keyboard connected to the aforementioned screen.

According to another aspect, a computer program is proposed comprising instructions for implementing the method such as defined herein when this program is executed by a processor. According to another aspect, a nonvolatile recording medium, readable by a processor, is proposed on which such a program is recorded.

### BRIEF DESCRIPTION OF THE DRAWINGS

Other characteristics, details and advantages will appear upon reading the following detailed description, and analyzing the attached drawings, on which:

FIG. 1 shows an example of a system for implementation of the above method, according to an embodiment.

FIG. 2 shows the main steps of an example of a method according to an implementation.

FIG. 3 shows a processing circuit comprising a processor, for example a server which could implement the method shown in FIG. 2 according to an implementation example.

### DETAILED DESCRIPTION OF THE INVENTION

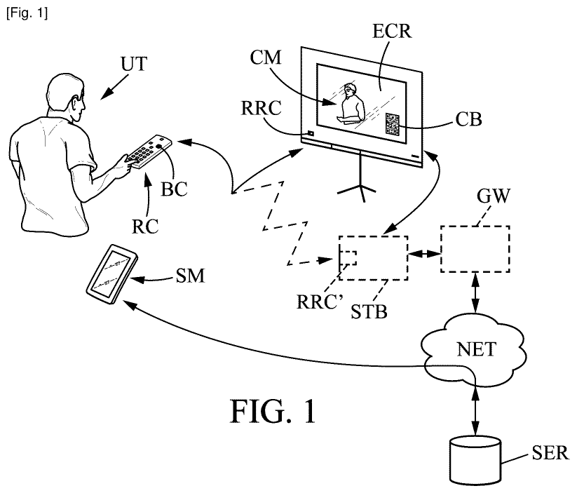

Now refer to FIG. 1. A connected screen ECR is linked via a wide area network NET to a server SER able to deliver multimedia content CM which may be displayed on the connected screen ECR. At a predefined moment of broadcasting the multimedia content, a visual code CB such as a barcode QRC appears in the content and the screen ECR then displays this code CB. The user UT viewing the multimedia content on the screen ECR has a remote control RC comprising in particular a specific button BC. Pressing on this button BC causes sending a remote control signal (for example infrared) received by a receiver RRC of the connected screen and interpreted by the connected screen ECR as being a request from the user UT to receive data associated with this visual code CB.

In the example shown in solid lines from FIG. 1, the connected screen ECR is part of a connected TV, capable of directly communicating with the remote server SER.

As a variant, the screen ECR may be connected to a terminal STB for receiving a video flow, for example a set-top box type. This terminal STB (shown in dotted lines in this variant) may itself be connected to the server SER for example by a gateway from a local network GW. In this variant, the remote control RC drives the operation of the terminal STB (for example for changing the broadcast channels, increasing the volume, etc.) and the terminal STB has for this purpose a receiver RRC' for receiving the remote control signals, and in particular the signal for requesting data associated with the visual code CB, which follows pressing on the specific button BC of the remote control.

In one or another of these embodiments, pressing on the button BC serves to send a request to the server SER, providing the content CM being broadcast, through a link according for example to the HBBTV protocol (Hybrid Broadcast Broadband TV) over IP, for example. Upon receiving this request, the content provider server SER sends a notification (by SMS or other) to the at least one second connected terminal, for example the smart phone of the user SM, with for example in the notification the data for a link with which the user UT can get access to a service associated with the code CB (the link for example gives access to a webpage showing such a service).

In order for the second terminal SM to be able to receive these data from the server, the user UT records in advance, with the content provider server SER, one or more smart phone(s) numbers IDSM associated with an identifier IDTV of their connected television (this identifier may for example be an email address, an IP address, or something else). This registration may be done directly in the client account of the user of the television, online on the client account of the content provider or even on the box GW of the Internet access provider.

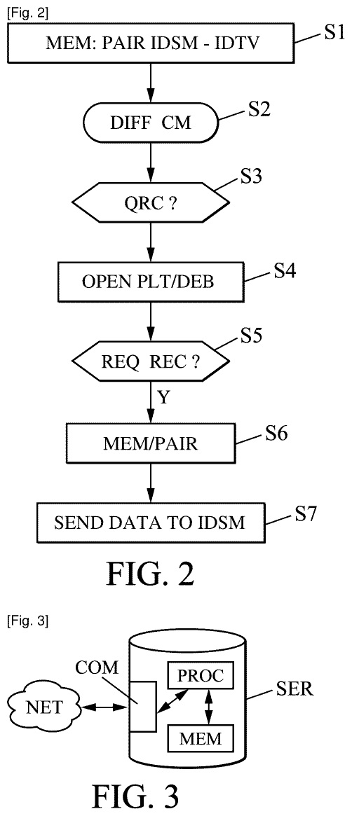

Thus, now referring to FIG. 2, in the example shown, during the first step S1, the server for example stores in memory at least one set of data for pairing a connected screen identifier and an identifier of the second terminal SM (for example an MSISDN number). During an ongoing step S2, the server next broadcasts multimedia content CM from a known timestamp. This broadcast may be done according to the HBBTV protocol (for example over IP), which allows adding metadata to the broadcast flow, in particular time domain metadata. Thus, the moment of beginning broadcasting of the content may be known, in particular from the connected screen, and also a possible moment of appearance of the visual code in the images of the content. At step S3, the connected screen (or the set-top box) may read these metadata and in particular determine whether such a visual code is or is soon going to be present in the images of the content. As applicable, the connected screen may then open a time span at step S4 which starts for example at the moment of expected appearance of the visual code in the multimedia content.

This time span may consider a reaction latency of the user and close well after the appearance of the code, for example several minutes after. Such an implementation allows the user to have time to react by pressing the specific remote control button in order to get the data associated with the visual code.

Alternatively, this time span may be open for hearing a specific succession of keywords (for example “access this service”) that the user could speak in order to access the data associated with this visual code, in an implementation where the human-machine interface is a voice interface. Advantageously, in this implementation, the operation of the connected screen is not disrupted if the user speaks such keywords in a different context, outside of this time span.

Of course, in another variant, the connected screen may bring up all the requests, for example if pressing the specific button of the remote control was detected. On its side, the server may open the aforementioned time window when a visual code is determined as having appeared in the images of the multimedia content being broadcast. Next, the server processes these requests if they arrive in this time window, or ignores them otherwise.

Of course, the preceding implementation, in which the connected screen itself filters the requests, may be preferred so as to not overload the network NET or the server SER.

In any one of these implementations, when the server receives such a request in step S5, the server may consult in the memory thereof the pairing data between the connected screen which is sending this request and the second terminal to which it must send the data for the access link to the service associated with the code which was just broadcast.

Advantageously, the request may contain, for example:
information about the program being broadcast (for example a specific TV network among a group of networks), allowing the server to identify the visual code which was inserted in this program;
a current timestamp in which the user pressed the specific remote control button, which may allow the server to confirm that this timestamp is in fact compatible with the moment intended for broadcasting the visual code in the given program, and that this timestamp is in fact in a current time span;
and at least one connected screen (or set-top box, or gateway) identifier such as an IP address or even an account address (email address or client account number at the content broadcasting service, or other), which allows the server to locate in the memory thereof, in step S6, the coordinates of the second terminal SM.

In step S7, the server then sends the data associated with the visual code to the second terminal in a message addressed according to the IDSM address of the second terminal according to the content of the memory thereof. Of course, the server may store several smart phone type terminal identifiers and send these data to a plurality of terminals.

Further, the choice of at least one terminal to which to send the notification may be left to the user. For example, upon action of the human-machine interface (remote control or voice), a choice may be proposed to the user by embedding in the display in progress on the screen in order to allow the user to select the second terminals to which they want the notification of the link to be sent (for example: all, or smart phone number 1 (which could be a pseudo-identifier type), smart phone number 2 (or pseudo-identifier), etc.) in order to receive the notification of the link on all the terminals or only on the selected terminals.

In this example from FIG. 2, the server may implement the illustrated steps S1 to S7. For this purpose, the server may comprise, as shown in FIG. 3, a communication interface, with a wide area network NET and also a processor PROC and storage memory MEM for storing in particular the pairing data. In an implementation example, this memory MEM also stores the instruction data for a computer program for implementing the method according to FIG. 2, when the processor PROC reads and executes these instructions.

Just the same, the embodiment according to which the method from FIG. 2 is implemented by a server allows possible variants. For example, the connected screen may temporarily store metadata from the HBBTV flow that may typically comprise data for the access link to the service associated with the visual code being displayed. Upon detection of pressing the specific button of the remote control, the connected screen finds in the temporary memory thereof these link data and sends them itself to the second terminal without going through the content server, for example via a gateway GW of the local network to which the screen ECR and the second terminal are connected (for example by Wi-Fi connection).

Further, a specific remote control button for connected television or set-top box type device was described above. Just the same, this specific button may also be provided on a computer keyboard (physical or tactile), where this keyboard is connected to a screen (of a computer, tablet, television or other).

1. A method for transmission of data associated with a visual code appearing at least temporarily in multimedia content during playing on a connected screen, the method comprising:
establishing a pairing between the screen and at least one second connected terminal, distinct from the connected screen;
at least during playing the multimedia content comprising said code, making available to a user of the screen a human-machine interface connected to the screen for sending a request for data associated with the visual code; and
upon receiving the request for data associated with the visual code by the connected screen, implementing a transmission of said data associated with the visual code to the second connected terminal;
the visual code appearing at a given timestamp after beginning of playing the multimedia content, a request for data associated with the visual code, coming from the connected screen, being interpreted as associated with the visual code if the request is received in a preset time span after said given timestamp.

2. The method according to claim 1, wherein, the screen being connected to a remote server for receiving and playing said multimedia content:
the connected screen sends to said remote server the request for data associated with the visual code, and
data of said pairing being stored in a memory of the remote server, the remote server, based on said pairing data, identifies the second terminal as recipient of the data associated with the visual code.

3. The method according to claim 1, wherein the second terminal receives said data in the form of an access link to a service associated with the visual code.

4. The method according to claim 1, wherein the multimedia content is received by the connected screen by implementation of a broadcast protocol.

5. The method according to claim 1, wherein the visual code comprises a barcode for which an optical reader is able to retrieve said data associated with the visual code, said data being associated with a service accessible through the second terminal, and wherein the human-machine interface uses a means distinct from an optical reader for requesting said data associated with the visual code.

6. The method according to claim 1, wherein the human-machine interface comprises a remote control comprising a specific button, pressing said specific button causing the transmission of said request for the data associated with the visual code.

7. The method according to claim 1, wherein the human-machine interface comprises a speech recognition module, a speaking by the user of at least one specific keyword causing the transmission of said request for the data associated with the visual code.

8. The method according to claim 1, wherein, the connected screen being integrated with a connected television, the human-machine interface available to the user comprises a television remote control, said remote control comprising a specific button for sending the request for said data associated with the visual code.

9. The method according to claim 1, wherein, the screen being connected to a terminal for receiving content, the terminal being of a type of a set-top box, the human-machine interface available to the user comprises a set-top box remote control, said remote control comprising a specific button for issuing the request for said data associated with the visual code.

10. A non-transitory computer readable storage medium, storing instructions of a computer program causing implementation of the method according to claim 1 when the instructions are executed by a processor.

11. A connected screen, configured for displaying multimedia content in which a visual code appears at least temporarily, the screen comprising:
a first communication interface with a human-machine interface for receiving a command to receive data associated with the visual code; and
a second communication interface with a remote server for sending a request for said data associated with the visual code to the server;
the visual code appearing at a given timestamp after beginning of playing the multimedia content, a request for data associated with the visual code, coming from the connected screen, being interpreted as associated with the visual code if the request is received in a preset time span after said given timestamp.

12. A system comprising at least one connected screen according to claim 11 and the human-machine interface.

13. The system according to claim 12, wherein the human-machine interface comprises a remote control comprising a specific button for sending the request for said data associated with the visual code.
